(19) United States
(12) Patent Application Publication
(10) Pub. No.: US 2002/0143615 A1
(43) Pub. Date: Oct. 3, 2002

(54) Information page system and method

(76) Inventors: Donald J. Palmer, Eagle, ID (US); Michael Vernon Thompson, Vancouver, WA (US); George Walter Lewis, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/819,230

(22) Filed: Mar. 28, 2001

(51) Int. Cl. G06F 17/60

(52) U.S. Cl. 705/14

(57) ABSTRACT

An information page system and method provides information to a consumer from an information station. The system includes the information station, an information database system with a database manager, and an information page printed by the information station using information provided from the information database system. The information page includes a feedback mechanism for submitting data representative of the information provided back to the information database system. In a method of providing information using information page system, a request for information is received from the consumer at the information station. The information, and an incentive related to the requested information, are retrieved from an information database. The information and the incentive are then printed on the information page for the consumer at the information station. Finally, using the feedback mechanism of the information page, data identifying the information and incentive provided to the consumer is submitted back to the information database system.

### THE FIELD OF THE INVENTION

The present invention is generally related to computer-based information systems and methods and in particular, is related to a computer-based information page system and method.

### BACKGROUND OF THE INVENTION

When traveling or shopping, obtaining timely information that is geographically and demographically relevant can be challenging. For example, consumers are frequently faced with the task of identifying a restaurant, hotel, transportation, or other services that suit their interests and that are within their immediate vicinity. Once a retail location is identified, consumers commonly also need directions and/or maps to get to a retail location.

One conventional manner of providing information is an automated information terminal. For example, a traveler at an airport that has rented a car may need directions to get to a business location or hotel. The consumer can ask an attendant for directions or request directions from the automated information terminal provided by the car agency. In response to a consumer request, the information terminal prints out directions and/or a map explaining to the consumer how to get to the desired location. Unfortunately, many of these automated information terminals offer very limited information. These terminals typically provide directions and maps of lesser quality, provide broadly targeted marketing information, and frequently do not provide additional information about restaurants, transportation, lodging, and leisure attractions, etc. Finally, once the information is provided to the consumer, the information provider generally has little or no idea if, how, and when the information was used, or who used the information.

Moreover, since the information provided to the consumer at an automated information terminal is generic, consumers may spend a considerable amount of time seeking and sorting that generic information to find specific information that is demographically relevant (i.e., suited to their tastes, income, gender, etc) and that is geographically relevant (i.e., aimed at retail locations near their lodging, business, travel route, etc.). Accordingly, while conventional automated information terminals offer stand-alone convenience in providing routine information (e.g. directions), they greatly underserve the needs of the traveling and/or shopping consumer.

### SUMMARY OF THE INVENTION

An information page system and method of the present invention provides information to a consumer from an information station. The system includes the information station, an information database system with a database manager, and an information page printed by the information station using information provided from the information database system. The information page includes a feedback mechanism for submitting data representative of the provided information back to the information database system.

In a method of the present invention of providing information using information page system, a request for information is received from the consumer at the information station. The information, and an incentive related to the requested information, are retrieved from an information database using choices selected by the database manager. The information and the incentive are then printed on the information page for the consumer at the information station. Finally, using the feedback mechanism of the information page, data identifying the information and incentive provided to the consumer optionally is submitted back to the information database system, and used to improve the quality of the data for subsequent use.

### BRIEF DESCRIPTION OF THE DRAWINGS

FIG. 1 is a block diagram illustrating one exemplary embodiment of an information page system of the present invention.

FIG. 2 is a flow diagram illustrating one exemplary embodiment of an information page method of the present invention.

FIG. 3 is a diagram illustrating one exemplary embodiment of a general menu display screen of an information page system of the present invention.

FIG. 4 is a diagram illustrating one exemplary embodiment of a specific menu display screen of an information page system of the present invention.

FIG. 5 is a diagram illustrating one exemplary embodiment of an incentive portion of an information page system of the present invention.

FIG. 6 is a flow diagram illustrating one exemplary embodiment of a customer relationship management feedback mechanism in an information page system and method of the present invention.

FIG. 7 is a diagram illustrating one exemplary embodiment of remote access to an information page system and method of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

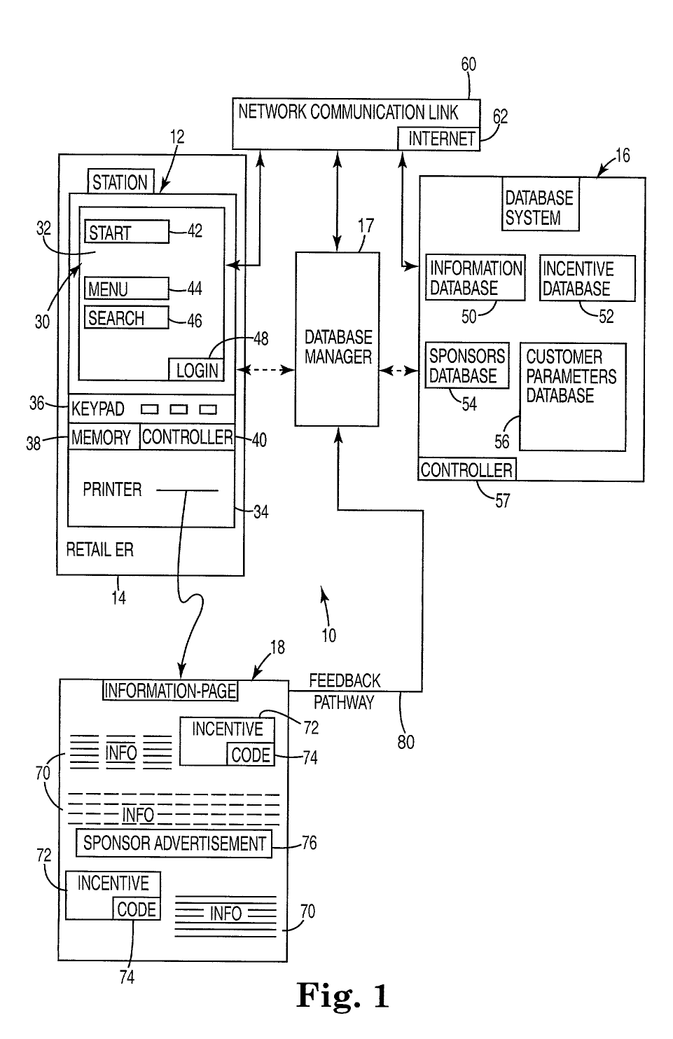

FIG. 1 illustrates one exemplary embodiment of an information page system and method of the present invention generally at 10. The information page system and method of the present invention enables consumers to conveniently obtain timely, geographically and demographically relevant information from an information station while traveling or shopping. Moreover, if the consumer identifies himself or herself to the information station either through a membership or account number (or other means), the information station will provide printed information and retailer incentives tailored closely to lifestyle preferences (i.e., user profile) of the identified consumer and/or targeted on the information requested. To do so, the system and method of the present invention provides an information page which includes the printed information and retailer incentives. The information page also acts as a feedback mechanism to a database system, which supports the information system and method, to enable the continual refinement of information and incentives provided to consumers as they use the information page system and method.

Components of the present invention can be implemented in hardware via a microprocessor, programmable logic, or state machine, in firmware, or in software within a given device. In one aspect, at least a portion of the software programming is web-based and written in HTML and JAVA programming languages, including links to graphical user interfaces for data collection, such as a windows based operating system, and each of the main components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may also reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory (RAM).

In one embodiment, system 10 includes information kiosk or station 12 within or adjacent retailer 14, information database system 16 with database manager 17, and information page 18. System 10 further comprises network communication link 60. In one preferred embodiment, information station 12 operates in a closed-loop information system 10 with information database system 16 to generate one or more information pages 18 based on a generated user profile. In one aspect, information station 12 communicates with information database system 16 to generate information page 18 via network communication link 60.

Information station 12 preferably is a stand-alone computer-based unit (e.g., a kiosk) located within a mall, airport retailer, sidewalk restaurant area or other venue frequented by consumers. In one aspect, information station 12 is located in or near areas in which consumers seek travel or shopping information. In one embodiment, information station 12 includes display 30, touchscreen interface 32, printer 34, keypad 36, memory 38, and controller 40. Touchscreen interface 32 further includes startup function 42, menu function 44, search function 46, and login function 48. Information system 12 includes touchscreen interface 32 (e.g., a graphical user interface) which permits operation of information station 12 by a user contacting a finger and/or stylus against display 30 to select functions appearing on display 30 using touchscreen technology as known to those skilled in the art. Touchscreen interface 32 can be implemented in hardware via a microprocessor, programmable logic device, or state machine, and firmware, or in software within a given device. In one aspect, at least a portion of the software programming is written in Java programming language, and station 12 communicates with database system 16 via network communication link 60 using a communication bus protocol. For example, the present invention optionally can use a TCP/IP protocol suite for data transport via communication link 60. In another aspect, the present invention does not use a TCP/IP protocol suite for data transport. Other programming languages and communication bus protocols suitable for use with station 12 will be apparent to those skilled in the art.

Touchscreen interface 32 further includes start function 42, menu function 44, search function 46, and login function 48. Start function 42 initiates operation of station 12 to permit a user to obtain information. Menu function 44 permits a user to view a menu of different categories of information that can be obtained from station 12. Search function 46 permits a user to enter their own keyword or category of information that they wish to obtain from station 12. Finally, login function 48 permits a user to identify themselves to station 12 in order to access the user's profile. In particular, login function 48 permits information page system 10 to provide information that is more closely and accurately tailored to meet the desires and needs of the user based on a profile of the user stored at database 16. For example, a regular customer of a rental car agency may enter their member or account number to identify their personal travel profile to information page system 10. This personal identification of the consumer permits system 10 to more accurately provide information and incentives to the known customer. Further, the user's profile can be dynamically updated based on each use of station 12.

Station controller 40 includes hardware, software, firmware or combination of these. In one preferred embodiment station controller 40 includes a computer server or other microprocessor based system capable of performing a sequence of logic operations and including memory 38 for storing information. In addition, station controller 40 can include a microprocessor embedded system/appliance incorporating tailored appliance hardware and/or dedicated single purpose hardware.

Printer 34 permits information stored or developed by station 12 to be printed out onto printed pages, termed information pages. One exemplary embodiment of an information page is illustrated as information page 18 (indicated as info-page). Keypad 36 permits entry of information request data, user identification information, or other data, into station 12.

Network communication link 60, as used herein, includes an Internet communication link, an intranet communication link, or similar high-speed communication link. In one preferred embodiment, network communication link 50 includes an Internet communication link 62. Internet communication link 62 permits communication between station 12, database system 16, and other auxiliary modules/components that communicate with station 12 and/or database system 16.

Database system 16 includes information database 50, incentive database 52, sponsor database 54, customer parameter database 56, all of which communicate with and are controlled by database manager 17. Each of databases 50, 52, 54, 56 may be independent of one another, or optionally, each of those databases may comprise portions of a single comprehensive database. Information database 50, incentive database 52, sponsor database 54, customer parameter database 56, database manager 17, use database technology and communicate via protocols known to those skilled in the art. Databases 50, 52, 54, 56 and manager 17 are described in detail later in this application. In one aspect, controller 57 for database system 16 is similar to station controller 40 previously described herein.

Database manager 17 acts as a controller over databases 50, 52, 54, 56 regulating the inclusion, exclusion, selection, and modification of data in those databases including selection and modification of the content, components, and style of each database. Accordingly, database manager 17 regulates all communication in and out of database system 16, including each of the individual database 50, 52, 54, 56. Of course database manager 17 selectively controls all of databases 50, 52, 54, 56, only a single database, or select combinations of databases 50, 52, 54, 56, all selected upon the discretion of the owner/operator of information station 12.

Database manager 17 includes hardware, software, firmware or combination of these. In one embodiment, the main components of database manager 17 are employed via software. In one embodiment, database manger 17 includes a computer server or other microprocessor based system capable of performing a sequence of logical operations and including a memory for temporary and/or persistent storage of information and instructions. Database manager 17 can include a microprocessor embedded system/appliance incorporating tailored appliance hardware and/or dedicated single purpose hardware. Database manager 17 may or may not be part of database 16. Database manager 17 operates to manage communication between station 12, database system 16, and information page 18, which may or may not be accomplished via network communication link 60.

Information page 18 is printed from printer 34 of station 12 in response to an information request made by the user at touchscreen interface 32. In one embodiment, information page 18 includes information 70, incentive 72 with code 74, sponsor advertisement 76, and database feedback path 80. Information page 18 includes information 70 that was requested by the consumer, and is provided in a graphical form, which may include text and/or graphical images. Incentive 72 is preferably a coupon, promotional offer, and/or identification of a retailer that is demographically related, geographically related, or otherwise related to information 70. Code 74 is associated with incentive 72 and acts as a tag to enable tracking use of the incentive 72 by the consumer, or even for tracking the mere providing of information 70 and/or incentive 72 to the consumer. Code 74 is structured for automated data entry of the tracking data regarding information 70 and incentive 72 into customer parameter database 56 via database manager 17 along feedback path 80. One exemplary embodiment of the relationship between incentive 72, code 74, and customer parameter database 56 is described in more detail later in this application.

Sponsor advertisement 76 of information page 18 provides a consumer with identification of, and information about, a retailer to entice the consumer to purchase goods and/or services from the retailer. Unlike retailers which are identified in incentive 72 that may only appear when information related to the incentive is requested, a sponsor identified in sponsor advertisement 76 always appears on information page 18 since the sponsor pays for its ongoing advertisement 76 through a fee-for-display contractual arrangement with the owner/operator of information station 12. This fee-for-display arrangement may provide sufficient income to completely offset management and printing cost of information station 12, or even generate a profit to the owner/operator of station 12. Information page 18 optionally includes no sponsor advertisement 76 as well as more than one sponsor advertisement 76. Similarly, the operator/owner of information station 12 optionally charges a fee-for-display charge to retailers identified in incentive 72 for each appearance of retailer on information page 18.

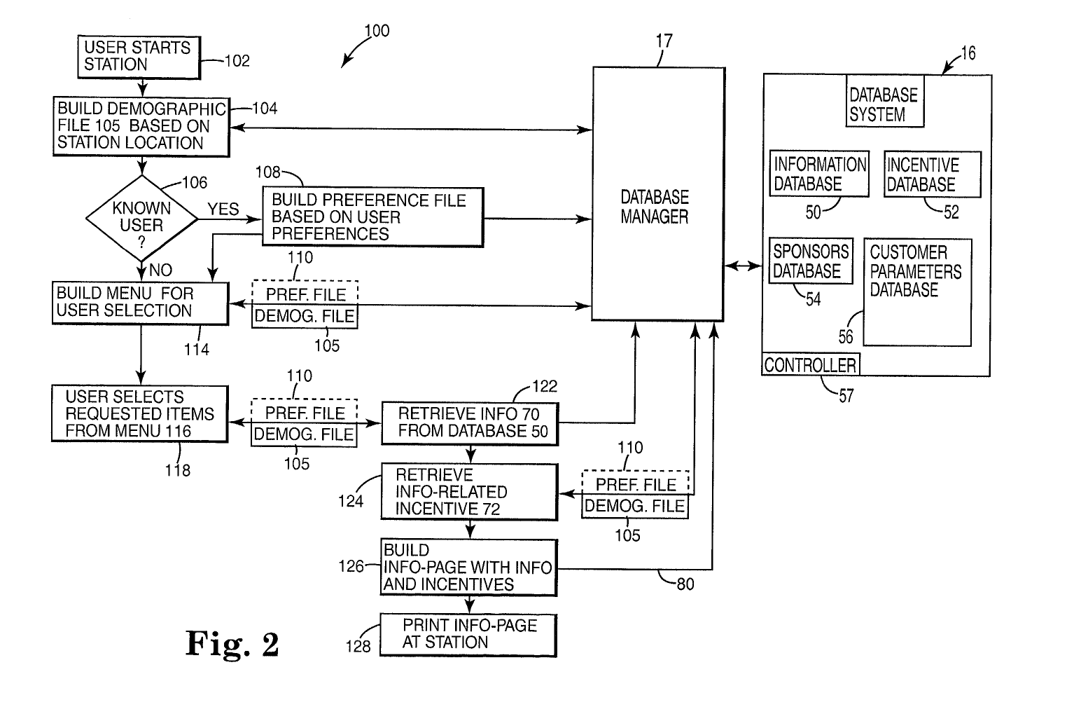

One exemplary embodiment of a method of providing information of the present invention with information page 18 using system 10 is illustrated generally in FIG. 2 at 100. In step 102, a user (or consumer) starts information station 12. In operation, station 12 uses customer parameter database 56 via database manager 17 to build user profiles, such as demographic file 105 based on the geographic and retail location of station 12, indicated at step 104. For example, station 12 can be identified as being in Boise, Id. in an upscale retail shopping center adjacent a women's clothing store. In step 106, station 12 determines whether the consumer is a known user or anonymous. The consumer will be considered anonymous unless the consumer or user is identified through login function 48 (FIG. 1) using a name, account number or customer number. If the user is known to system 10, then the next step includes building preference file 110 using user preferences 112 stored in, and retrieved from, customer parameter database 56 via database manager 17, as indicated at step 108. In one aspect, user preferences 112 include identification of the consumer's tastes, buying habits, and socioeconomic data, etc. that together comprise a personality signature uniquely identifying the consumer, or type of consumer. With this data loaded into preference file 110, information system 10 more accurately provides information and/or incentives for this information request that are useful and desired by the consumer.

With database manager 17, each information request produces an iterative refining process that further develops the personality signature of the consumer and the shape and scope of database system 16 to yield even more useful and accurate information 70 and incentives 72 for the consumer. This process permits the characteristics of information page 18 to be framed around unique individual preferences, such as the personality signature, rather than merely general geographic or demographic factors. In effect, this feature allows marketing to consumers to begin at a higher threshold or starting point of information and incentives that more likely appeal to that particular consumers habits and preferences. This personality signature allows sponsor or retailers (that provide incentives 72) to appeal directly to the emotions or personality of the consumer, effectively bypassing conventional direct sales techniques (e.g. salesmen, direct mail marketing, etc.). The personality signature can be used to shape the appearance and type of incentives for each consumer so that while a single promotional offer may be offered to multiple consumers, each consumer receive the promotional offer in a slightly different appearance which is tailored to their particular preferences based upon their unique personality signature. Of course, information system 10 can be selectively monitored to cause multiple consumers to receive promotional offers that have exactly the same appearance or style for each consumer.

Whether the consumer is known or anonymous in step 114, the next step includes building a menu 116 to enable consumer selection of the desired information. Menu 116 is built from information database 50 via database manager 17 using a demographic file 105 to tailor the information based upon the location of station 12 and optionally based upon preference file 110 when the consumer has a known identity to system 10. At step 118, upon viewing menu 116, the consumer selects requested items 120 of information from menu 116. At step 122, the requested information items 120 are paired with demographic file 105 and preference file 110 to retrieve information 70 from information database 50 via database manager 17. In step 124, information station 12 retrieves information-related incentives 72, using preference file 110 and demographic file 105, from incentive database 50 via database manager 17. Having retrieved both the requested information 70 and information-related incentives 72 from database system 16, information station 12 builds information page 18 for consumption by the consumer, indicated at step 126. Once information page 18 is built, data about selected information 70 and incentive 72 is transmitted to customer parameter database 56 via feedback path 80 and database manager 17 to update customer parameter database 56 as to what information was provided to information station 12, and if the consumer was known, what information and incentives were provided to this particular consumer. In step 128, information page 18 is printed at station 12 via printer 34.

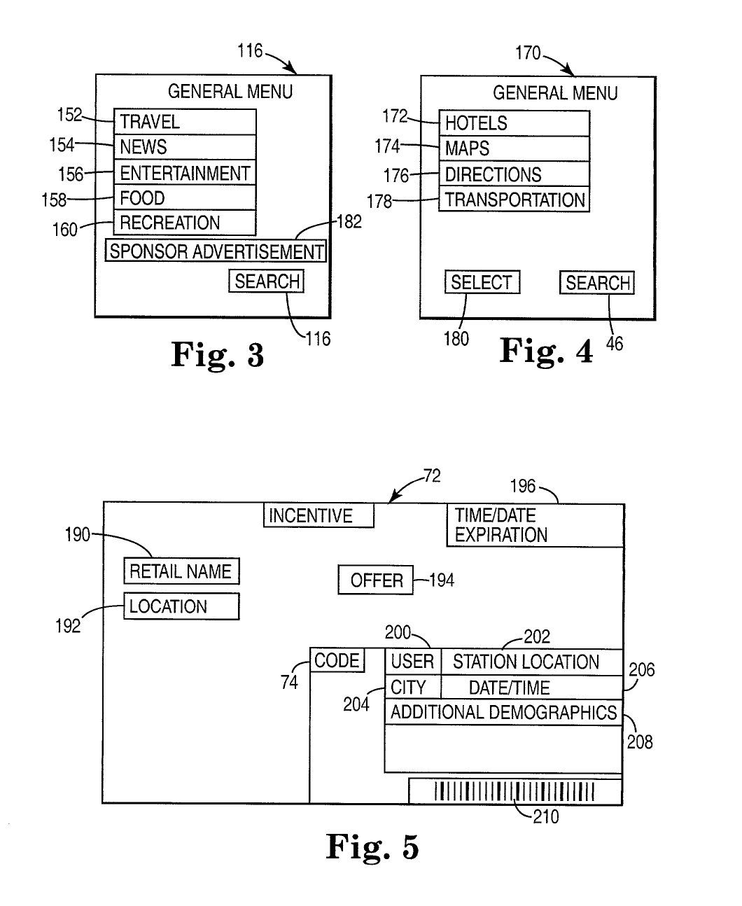

FIG. 3 is a diagram of a menu 116 (built as illustrated in step 114 shown in FIG. 2). General menu 116 is displayed on touchscreen interface 32 upon user activation of menu function 44 (FIG. 1). General menu 116 includes a plurality of category-keyword functions including travel keyword 152, news keyword 154, entertainment keyword 156, food keyword 158, and recreation keyword 160. Menu 116 optionally further includes sponsor advertisement 182 identifying a retailer through whom services are goods may be acquired. Sponsor advertisement 182 is arranged by a fee-for-display contract arrangement between a retailer and the operator/owner of information station 12, or between a retailer and the operator/owner of information database system 16. Sponsor advertisement 182 optionally appears in any menu or page of touchscreen interface 32.

Upon activation of any the menu keywords, a more detailed menu specifying information 70 or further choices regarding the particular keyword is displayed on touchscreen interface 32. For example, activation of travel keyword 152 on general menu 116, results in display of travel menu 170 on touchscreen interface 32, as shown in FIG. 4. Travel menu includes hotels function 72, maps function 74, directions function 176, and transportation function 178. Upon activation of any of these functions, more detailed information 70 regarding each of those categories is provided to the user. In addition, using the search function 46, the user can search for categories of information, or detailed information not listed on any menu or page displayed on touchscreen interface 32. Accordingly, the user continues to activate menu driven functions until the desired information 70 is identified. Once the desired information 70 is located, the user activates select function 180 to mark the identified information 70 for printing on information page 18. Select function 180 is also optionally displayed on all menus and pages of touchscreen interface 32 to permit a selection of information 70 at any desired level of detail.

Along with information 70 that is printed on information page 18 (FIG. 1), system 10 also identifies and selects incentive 72 for printing alongside information 70 on information page 18. FIG. 5 provides an example of incentive 72 as printed on information page 18. As shown in FIG. 5, incentive 72 includes retailer name 190, retailer location 192, promotional offer 194, and time/date expiration 196. Retailer name 190 identifies the name of the retailer to which the consumer is encouraged to go. Retail location 192 identifies a geographic location of a retailer while promotional offer 194 (e.g., coupons, discounts, premiums, etc.) further entices the consumer go to the retailer. Time/date expiration 186 optionally provides a time limit for using promotional offer 194.

Incentive 72 further comprises code 74, which includes user identification 200, geographic location 202 of information station 12, city identification 204, date/time identification 206, and additional demographics 208. Finally, code 74 includes barcode 210 (or a similar electronically readable symbolic coding mechanism) to permit electronic transmission and downloading of this identified data on code 74 to information database system 16.

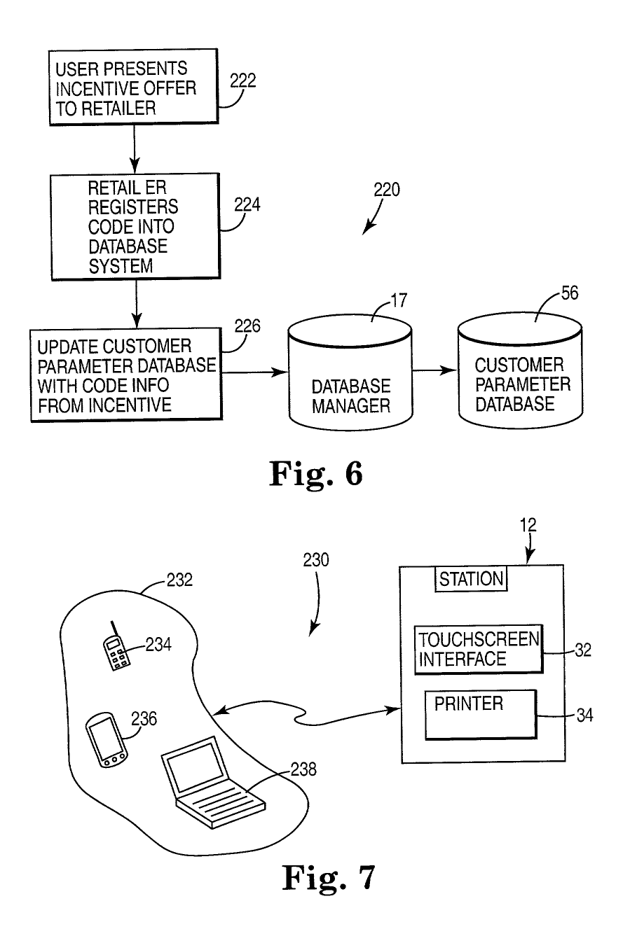

Code 74 generally establishes a set of information for entry into customer parameter database 56 via database manager 17 along feedback path 80 after the consumer uses incentive 72. Code 74 acts as a tag for identifying and tracking if, how, and when information page 18, particularly incentive 72, is used by the consumer. This feedback process is described in more detail later in association with FIG. 6. Accordingly, user identification 200 of code 74 identifies the identity of user 200, if known, while geographic station location 202 identifies the demographic and/or geographic location of station 12. Similarly, city location 204 of code 74 further identifies the geographic location while date/time identification 206 provides temporal data regarding the printing of information page 18. Finally, additional demographics identification 208 of code 74 permits any other desirable information regarding the provision or use of incentive 72 to be carried on code 74 for ultimate entry into customer parameter database 56. Barcode 210 is provided as an example for use with an electronic means for transmitting all of the identified information in code 74 into customer parameter database 56. Of course, other electronically readable coding mechanisms known to those skilled in the art may be used.

Information page 18 is an active component of information system 10. In particular, as shown in FIG. 6, information page 18 forms part of feedback path 80 between information station 12 and database system 16 including database manager 17 and customer parameter database 56. As shown in FIG. 6, in a first step the user presents incentive offer 194 to retailer 14 (step 222). Retailer 14 then submits code 74 for entry into database system 16, using barcode 210, or other data entry mechanisms (step 224). Finally, customer parameter database 56 is updated with code information 74 from incentive 72 (step 226). Customer parameter database 56, as well as, database system 16 as a whole, may be operated and maintained by the owner/operator of information station 12, an independent third party, and/or one of the sponsors or retailers providing incentives 72 and/or information 70.

In process 200, upon use of incentive 72 and a retailer's data entry of incentive 72 into database system 16, database manager 17 operates on the rest of the database system 16, including customer parameter database 56, to continually and iteratively refine the type, quality and quantity of information provided to consumers based on demographic factors, geographic factors, and consumer identity (if known). At the same time, database manager 58 modifies the shape, content, components and style of information database system 16 including databases 50-56. In addition, this process refines the developing picture of the personality signature of known consumers, or types of consumers, so that information system 10 better targets those consumers with information 70 and incentives 72 to meet their needs so that the consumers will be more likely to use information system 10 again.

While information station 12 will most likely be accessed in person, FIG. 7 illustrates an auxiliary input/output system in which the request for information 70 from station 12 is made remotely and information page 18 is printed at information station 12. Alternatively, the request is made directly at information station 12 for later reception of information page 18 electronically in the auxiliary/input output devices to be printed later at an auxiliary printer. In particular, auxiliary system 230 includes auxiliary input/output devices 232 including mobile phone 234, personal digital assistant (PDA) 236, and portable computer 238. Each of these devices 232 is capable of wirelessly transmitting an information request to information station 12 via network communication link 60 in a manner well known to those skilled the art of wireless network communications. Accordingly, a user can remotely use PDA 236 to make an information request of information station 12 for printing at station 12 so that upon the user's arrival at station 12, information page 18 is already available for pickup at printer 34. In a more detailed example, a traveler flying in an airplane can use laptop computer 238 or PDA 236 to make an information request from information station 12 located at a destination airport. By making the information request remotely, information page 18 will be printed and made available at printer 34 of information station 12 for immediate pickup.

Conversely, a user at station 12 can operate touchscreen interface 32 of display 30 to make an information request of system 10, which is then printed electronically on any one of the auxiliary devices 232, such as personal digital assistant 236. Accordingly information page 18 optionally can be provided in into an electronic form on a display of one of the auxiliary device 232. In this instance, incentive 72 including code 74 would be provided in an electronic form that is either printable via PDA 236 (or other devices 230) for submission to a retailer, or provided in a form with appropriate data to permit acceptance of the incentive 72 by the retailer.

Moreover, in the situation in which the user is known to customer parameter database 56, and the user requests information about a restaurant in the vicinity of a destination at which the consumer will be arriving, customer parameter database 56 will provide detailed information specific to the known consumer such as the type of restaurant that the consumer prefers (e.g., upscale, seafood) based upon past purchases and use of incentives 72.

Whether using auxiliary input/output system shown FIG. 7 or the more general information system 10 shown in FIGS. 1-6, upon successive iterations of the operation in the system and method of the present invention, database system 16 will further refine incentives 72 and information 70 provided in information page 18 based upon the evolving personality signature of the consumer so that consumers needs will be met more often. This process will also improve the success rate of information system 10 in marketing information 70 or an/or incentive 72 to consumers. Accordingly, in the example of identifying consumer preferences, for an upscale seafood restaurant in an earlier iteration of information system 10, later iterations of information system 10 will yield further preferences such as a consumer preference for red wine, lobster and valet parking. Information page 18 will reflect these consumer preferences in a highly focused incentive 72, for example, a coupon from a favorite seafood restaurant with a red wine and lobster special and with complimentary valet parking.

Accordingly, an information page system and method of the present invention carries numerous advantages. First, the more information station 12 is used by either anonymous users or known consumers, to obtain information 70 and incentives 72, database manager 17 operates on database system 16 including customer parameter database 56 to better refine its sorting of information and incentives to better target consumers with information and incentives that are geographically, and demographically relevant to those consumers frequenting station 12. Of course, database manager 17 and database system 16 including customer parameter database 56 perform best when providing information and incentives based on geographic, demographic and preference factors linked to known customers. Upon redemption of each incentive 72 and the retailer submission of that incentive 72 back to information database system 16 via database manager 17, customer parameter database 56 iteratively refines its selection and sorting of information and incentives for consumers. In this manner, information page 18 in a system and method of the present invention operates as an active link in a closed-loop feedback pathway between information station 12 and information database system 16 with database manager 17, particularly with customer parameter database 56.

While the system and method of the present invention is convenient for consumers, the system and method can be highly economically profitable to an owner/operator, sponsor, and/or retailer since the value of incentives 72 to each organization is heightened with the ever-increasing accuracy of targeting of information and incentives to the consumers. Moreover, the ever-increasing rate of the consumer actually using the offered information and incentives increases the value of the information and incentives.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of providing information to a consumer from an information station comprising:
receiving a request for information from the consumer to the information station;
retrieving the information and an incentive related to the requested information from an information database system;
printing the information and the incentive on an information page for the consumer at the information station; and
submitting to the information database system data identifying the information and the incentive provided to the consumer.

2. The method of claim 1, wherein the printing step further comprises:
specifying the incentive to identify a retailer including the location of the retailer and a time-limited promotional offer of goods or services sold by the retailer.

3. The method of claim 1, wherein the retrieving step further comprises:
retrieving the incentive from an incentive database of the information database system.

4. The method of claim 1, wherein the printing step further comprises:
printing the incentive to include at least one of an identification of:
user data, a geographic/demographic location of the information station, city data, date/time data, or additional demographic data.

5. The method of claim 1, wherein the printing step further includes printing a code on the information page to include a bar-code mechanism for electronically performing the submitting of the data to the information database system to identify the information and the incentive provided to the customer.

6. The method of claim 1, wherein the retrieving step further comprises:
sorting and selecting the information and the incentives produced from the information database system using geographic, demographic, or user-preference criteria retrieved from a customer parameters database of the information database system.

7. The method of claim 6, wherein after the incentive from the information page is used at a retailer, the method further comprises:
submitting data representing the incentive from the retailer to the customer parameter database for updating the customer parameter database with demographic, geographic and user-preference data.

8. The method of claim 1, further comprising:
displaying a keyword-based menu in a user interface of the information station to enable user selection of desired information; and
building the keyword-based menu based on geographic and demographic parameters regarding the information station.

9. The method of claim 1, wherein the receiving step further comprises:
receiving identification of an identity of the user and retrieving the user preference criteria associated with the identified user for refining selection of information and incentives desired by the user.

10. The method of claim 1, wherein the transmitting step further comprises:
sending the consumer-related information and incentive data to a customer parameters database of the information database system.

11. The method of claim 1, further comprising:
making the request for information at the information station.

12. The method of claim 1, further comprising:
making the request for information remotely from the information station using a mobile computing device via a wireless communication link.

13. The method of claim 1, wherein the printing step further comprises:
electronically printing the information page including the information and the incentives remotely from the information station at a mobile computing device via a wireless communication link.

14. The method of claim 1, further comprising:
locating the information station remotely from the information database system; and
transmitting the information and the incentive from the information database system to the information station.

15. The method of claim 1, and further comprising:
managing the information database system with a database manager to selectively modify the components, style, and scope of the information database system for optimizing accuracy of the information database system in identifying consumers and in providing relevant information and incentives to the consumer.

16. An information system comprising:
an information station;
an information database system; and
an information page printed by the information station using information provided from the information database system and including a feedback mechanism for submitting data representative of the information back to the information database system.

17. The system of claim 16, further comprising:
a network communication link to enable communication between the information station and the information database system.

18. The system of claim 16, wherein the information page further comprises:
information, an incentive, and optionally includes a sponsor advertisement.

19. The system of claim 18, wherein the incentive further comprises:
identification of a retailer, a retailer location, a promotional offer, and a time-limit for the promotional offer.

20. The system of claim 19, wherein the incentive further comprises:
a code identifying a user, a station location, a city, a date/time, an additional demographics parameter, and a bar-code mechanism.

21. The system of claim 16, wherein the information database system further includes an information database, an incentive database, and a customer parameter database.

22. The system of claim 16, and further comprising:
a database manager linked to the information database system for selectively modifying the components, style, and scope of the information database system to optimize accuracy of the information database system in identifying consumers and in providing relevant information and incentives to the consumer.

23. A method of maintaining an information database with a closed loop data feedback system comprising:
requesting information from the information database via an information station;
selecting and acting upon the information database with a database manager to target information and incentives to the consumer;
printing information and incentives related to the information requested at the information station;
tagging the incentive within an identification code for tracking use of the incentive;
recording the identification code data into the information database upon use of the incentive; and
refining the information database with the database manager upon entry of the identification code data into the information database; and refining the database manager.

24. A method of marketing using an information database system comprising:
identifying a consumer based upon at least one of the following parameters: geographic; demographic; socioeconomic; gender; and account number;
providing information and incentives to a consumer from the information database system;
receiving feedback into the information database system along a feedback pathway regarding if, how, and when the information and incentives were used by the consumer;
developing a personality signature of the consumer based upon iterative repeated operations of the providing step; and
shaping further information and incentives provided to the consumer based upon the personality signature of the consumer.

25. The method of claim 24, wherein the receiving step further comprises: tagging the incentives with an identification code to enable tracking use of the incentives and to enable entry of data relating to use of the incentive into the information database system.

26. A computer-readable medium having computer-executable instructions for performing a method of providing information to a consumer from an information station, the method comprising:
receiving a request for information from the consumer to the information station;
retrieving the information and an incentive related to the requested information from an information database system;
printing the information and the incentive on an information page for the consumer at the information station; and
submitting to the information database system data identifying the information and the incentive provided to the consumer.
